(19) United States
(12) Patent Application Publication
(10) Pub. No.: US 2026/0167177 A1
(43) Pub. Date: Jun. 18, 2026

(54) METHOD AND APPARATUS FOR SURROUND VIEW MONITOR-BASED PARKING ASSISTANCE USING A MACHINE LEARNING MODEL

(71) Applicants: HYUNDAI MOTOR COMPANY, Seoul (KR); KIA CORPORATION, Seoul (KR)

(72) Inventor: Min Chul Kang, Hwaseong-si (KR)

(73) Assignees: HYUNDAI MOTOR COMPANY, Seoul (KR); KIA CORPORATION, Seoul (KR)

(21) Appl. No.: 19/362,814

(22) Filed: Oct. 20, 2025

(30) Foreign Application Priority Data
Dec. 16, 2024 (KR) 10-2024-0187166

(51) Int. Cl. B60W 30/06; B60R 1/27; B60W 50/14; G06V 10/44; G06V 10/70; G06V 20/58

(52) U.S. Cl. CPC B60W 30/06; B60R 1/27; B60W 50/14; G06V 10/44; G06V 10/70; G06V 20/586; B60R 2300/105; B60R 2300/305; B60R 2300/607; B60R 2300/806; B60W 2050/146; B60W 2420/403

(57) ABSTRACT

A computer implementation method for performing a method for SVM-based parking assistance by utilizing a machine learning model, the computer implementation method comprising: acquiring a vehicle surrounding image using a plurality of cameras; detecting, by the machine learning model, feature points of an edge and a corner of a parking space based on the vehicle surrounding image, calculating a distance between the feature points, and estimating at least one of a location, length, or width of the parking space; and providing the vehicle surrounding image and visual information together on a display of a vehicle so that the vehicle is able to determine whether it is possible to park in the parking space.

### CROSS-REFERENCE TO RELATED APPLICATION

This application claims the benefit of and priority to Korean Patent Application No. 10-2024-0187166, filed on Dec. 16, 2024, the entire contents of which are hereby incorporated herein by reference.

### TECHNICAL FIELD

The present disclosure relates to a method and an apparatus for surround view monitor (SVM)-based parking assistance by utilizing a machine learning model. More particularly, the present disclosure relates to a method and an apparatus for providing information helpful for parking to a driver on a display by utilizing a function of a machine learning model in an SVM system.

### BACKGROUND

The contents described below merely provide background information related to the present disclosure and does not constitute prior art.

A surround view monitor (SVM) refers to a device that synthesizes images captured by cameras installed on the front, back, left, and right of a vehicle. Thus, fields of view (FOV) of the device are converted into one image to provide a top view image that is similar to a top view image of the surroundings of the vehicle from above the vehicle. The SVM is also referred to as an around view monitor (AVM) or bird's eye view (BVM). By using an SVM system, a driver may reduce a blind spot of the vehicle and may easily perform parking in a narrow space. However, the existing SVM system simply provides visual information and has limitations in determining whether parking is available in a parking space or providing appropriate feedback to the driver in real time.

Machine learning is a technology that may solve complex problems based on data learning. Machine learning technology may also be used in SVM systems. As a technology that applies machine learning, distance map (DM) and depth estimation DE technologies may precisely calculate a distance and depth to an object in an image and may analyze a structure of a parking space. Segmentation technology divides a region in the image including the parking space and determines whether a specific region is suitable for parking. This includes techniques, such as object detection (OD), space detection SD, object classification (OC), and space segmentation (SS).

Augmented reality (AR) technology is a technology that superimposes virtual information on the real world and provides visual, auditory, and tactile feedback to the user to reinforce the real environment. The AR technology analyzes a real environment in real time using devices, such as cameras, sensors, and displays and provides information by mapping virtual objects. For example, the AR technology displays parking available spaces, paths, warnings, etc. in real time on images collected by cameras to support vehicle control.

Various parking assistance systems exist to support drivers'parking. Remote smart parking assist (RSPA) searches for parking spaces by utilizing vehicle's sensors and cameras and automatically controls steering, speed, and gear shifting to enable drivers to remotely park from inside or outside the vehicle. The RSPA is also referred to as remote parking assist, autonomous parking system. Rear view monitor (RVM) displays a situation behind a vehicle in real time on a display using a rear camera, helping drivers check rear obstacles and the surrounding environment when reversing. Parking distance warning (PDW) measures a distance between a vehicle and a surrounding obstacle using ultrasonic sensors and warns the driver visually or audibly based on the measured distance to prevent a collision in narrow spaces. Parking collision-avoidance assist (PCA) detects an obstacle on a parking path using the vehicle's camera and ultrasonic sensor and provides a warning when there is a risk of collision or performs automatic braking when necessary to prevent an accident. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

An object of the present disclosure is to provide a method and an apparatus for a surround view monitor (SVM)-based parking assistance by utilizing machine learning model.

The present disclosure provides visual information, such as surrounding vehicles, parking spaces, and parking completion screens that are helpful when driving and parking a vehicle by using a machine learning model, as well as providing a surrounding image of the vehicle including an SVM system to a driver of the vehicle.

The problem to be solved by the present disclosure is not limited to the problems mentioned above, and other problems not mentioned may be clearly understood by those having ordinary skill in the art from the description below.

An embodiment of the present disclosure provides a computer implementation method for performing a method for a surround view monitor (SVM)-based parking assistance by utilizing a machine learning model. The method includes acquiring, by a plurality of cameras, a vehicle surrounding image. The method further includes detecting, by the machine learning model, feature points of an edge and a corner of a parking space based on the vehicle surrounding image. The method further includes calculating, by the machine learning model, a distance between the feature points. The method further includes estimating, by the machine learning model, at least one of a location, a length, or a width of the parking space. The method further includes providing, by a control module, the vehicle surrounding image and visual information on a display of a vehicle. The method further includes determining, by the vehicle, whether it is possible to park in the parking space. The method further includes performing, by the vehicle, autonomous parking based on a result of whether it is possible to park in the parking space.

Another embodiment of the present disclosure provides an apparatus for SVM-based parking assistance by utilizing a machine learning model.

The apparatus includes at least one memory configured to store instructions; and at least one processor. The at least one processor is configured, by executing the instructions, to acquire a vehicle surrounding image by using a plurality of cameras. The at least one processor is further configured to detect feature points of an edge and a corner of a parking space based on the vehicle surrounding image by using the machine learning model. The at least one processor is further configured to calculate a distance between the feature points by using the machine learning model. The at least one processor is further configured to estimate at least one of a location, a length, or a width of the parking space by using the machine learning model. The at least one processor is further configured to provide the vehicle surrounding image and visual information on a display of a vehicle. The at least one processor is further configured to determine whether it is possible to park in the parking space. The at least one processor is further configured to perform autonomous parking based on a result of whether it is possible to park in the parking space.

According to an embodiment of the present disclosure, by providing the driver with visual information that is helpful for driving and parking, such as surrounding vehicles, obstacles, and parking spaces, etc. obtained using a machine learning model in addition to the vehicle surrounding images provided by the SVM system, the driver may be assisted in driving and parking based on the provided information.

According to an embodiment of the present disclosure, by providing a parking completion prediction screen, the driver may utilize a parking assistance system in conjunction when he or she cannot get in or out of the vehicle.

The effects of the present disclosure are not limited to the effects mentioned above, and other effects that are not mentioned may be clearly understood by those having ordinary skill in the art from the description below.

### BRIEF DESCRIPTION OF THE DRAWINGS

FIG. 1 is a block diagram of an apparatus for surround view monitor (SVM)-based parking assistance by utilizing machine learning model according to an embodiment of the present disclosure.

FIG. 2 is a diagram illustrating a camera attached to a vehicle including an SVM system according to an embodiment of the present disclosure.

FIG. 3 is a diagram illustrating a display attached to a vehicle including an apparatus for SVM-based parking assistance according to an embodiment of the present disclosure.

FIG. 4A-FIG. 4F are diagrams illustrating a sequence of operations from an operation before a vehicle to which an apparatus for SVM-based parking assistance is applied approaches a projected parking location to perform parking to an operation of moving backward to perform parking according to an embodiment of the present disclosure.

FIG. 5 is a flowchart schematically illustrating a process in which a vehicle including an apparatus for SVM-based parking assistance performs parking according to an embodiment of the present disclosure.

FIG. 6 is a diagram illustrating a configuration of a computing device that may be used to implement the apparatus and methods described in the present disclosure.

### DETAILED DESCRIPTION

Hereinafter, some embodiments of the present disclosure are described in detail with reference to the accompanying drawings. In the following description, like reference numerals designate like elements, although the elements are shown in different drawings. Further, in some embodiments, a detailed description of known functions and configurations incorporated therein has been omitted for the purpose of clarity and for brevity.

Additionally, various terms such as first, second, A, B, (a), (b), etc., are used solely to differentiate one component from another component and are not intended to imply or suggest the substances, order, or sequence of the components. Throughout the present disclosure, when a part ‘includes’ or ‘comprises’ a component, the part is meant to further include other components and is not intended to exclude thereof unless specifically stated to the contrary. The terms, such as ‘unit’, ‘module’, and the like, refer to one or more units for processing at least one function or operation, which may be implemented by hardware, software, or a combination thereof. When a controller, unit, module, component, device, element, or the like of the present disclosure is described as having a purpose or performing an operation, function, or the like, the controller, unit module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

The following detailed description, together with the accompanying drawings, is intended to describe embodiments of the present invention and is not intended to represent the only embodiments in which the present disclosure may be practiced.

The term ‘parking location’ in the present disclosure refers to a specific rectangular region in which a vehicle may be safely parked and includes an edge and a corner. The edge (a parking line) indicates a boundary of a parking space, and the corner is defined as an intersection of the edges.

The term ‘projected parking location’ in the present disclosure refers to a potential space, which is available for a vehicle to park and is a specific region evaluated to determine whether a vehicle may be parked or whether a driver may get in or out of a vehicle when parking is completed.

The terms ‘parking space’ and ‘projected parking location’ in the present disclosure may be used interchangeably.

In the present disclosure, ‘parking availability’ or “parking possibility” may be determined based on whether the length and the width of a parking space may accommodate the length, the wheelbase, the width, or the tread of a vehicle, whether there are no obstacles in the parking space, whether there are no obstacles in an entry path of the parking space, and/or whether the vehicle may be safely and accurately parked by considering a turning radius and steering angle of the vehicle, etc.

In the present disclosure, ‘whether the driver may get in/out of the vehicle after parking is completed’ may be determined based on whether a vehicle door opening space and a pedestrian space for a safe movement of the driver or a passenger are sufficiently secured while the vehicle is parked.

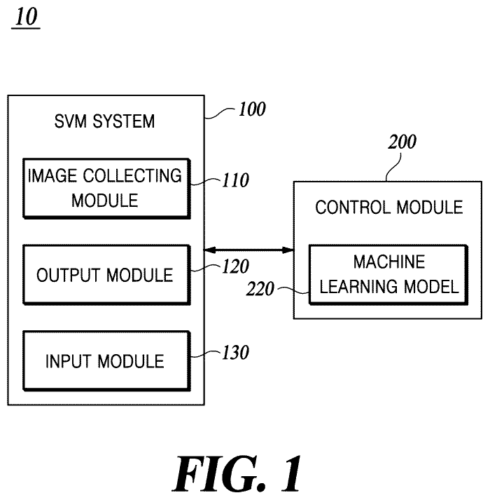

FIG. 1 is a block diagram of an apparatus for surround view monitor (SVM)-based parking assistance by utilizing machine learning technology according to an embodiment of the present disclosure.

The apparatus 10 for SVM-based parking assistance according to the present disclosure may display information on a projected parking location in real time on a display by using augmented reality technology. The information on the projected parking location is obtained using a machine learning model. Based on the information on the projected parking location, a driver may decide on whether to perform manual parking or autonomous parking, such as a remote smart parking assistance (RSPA) function.

Referring to FIG. 1, the apparatus 10 for SVM-based parking assistance may include an SVM system 100 and a control module 200. The components illustrated in FIG. 1 represent functionally distinct elements, and at least one component may be implemented to be integrated with each other in an actual physical environment. It should be readily understood by those having ordinary skill in the art that mutual positions of the components may be changed in response to the performance or structure of the system.

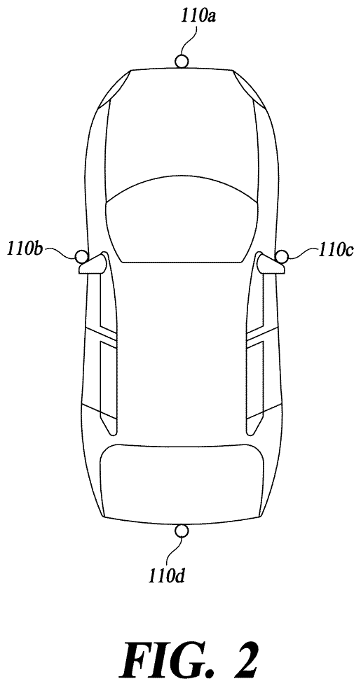

FIG. 2 is a diagram illustrating a camera attached to a vehicle including an SVM system according to an embodiment of the present disclosure.

The SVM system 100 may include an image collecting module 110, an output module 120, and an input module 130.

The image collecting module 110 may include a plurality of cameras 110a to 110d. For example, the cameras 110a to 110d may be located in the front, rear, and/or left and right sides of the vehicle, which are full surroundings. For example, the image collecting module 110 may collect surrounding images including parking spaces and obstacles (e.g., surrounding vehicles, pedestrians, pillars, etc.) by imaging the full surroundings of the vehicle using the cameras 110a to 110d. For example, the image collecting module 110 may synthesize the images obtained by imaging the full surroundings of the vehicle using the cameras 110a to 110d to generate an image that display the surroundings of the vehicle in various views. In other words, an image that displays a 360° variable 3D view may be generated. The image collecting module 110 may provide the collected surrounding image or the generated image to the control module 200. Because the method of generating a vehicle surrounding image using a plurality of cameras 110a to 110d of the SVM system is known in the art, a detailed description thereof has been omitted.

The cameras 110a to 110d may include an image sensor, such as a complementary metal-oxide semiconductor (CMOS), a charge-coupled device (CCD), an active pixel sensor, and one of a rectilinear lens, a concave lens, a convex lens, a wide-angle lens, or a fish-eye lens. The cameras 110a to 110d may be analog type cameras or digital cameras.

The output module 120 may display a top-view image using a display. The top-view image may include a driver's vehicle, surrounding vehicles, a projected parking location, etc. The display of the output module 120 may include one or more of an LCD display, an OLED display, an LED display, a flat panel display, and a head-up display (HUD), but is not limited thereto.

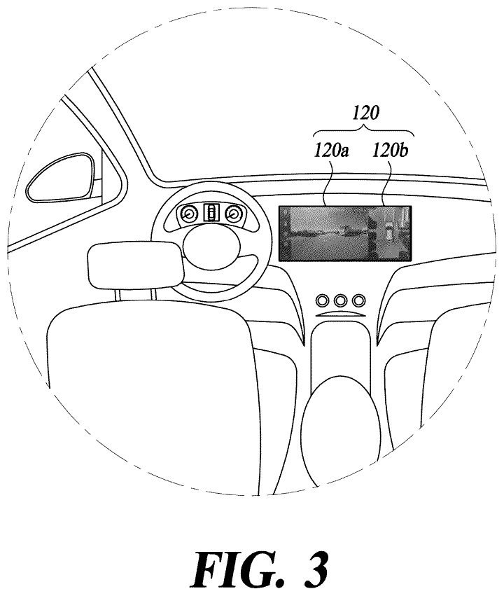

FIG. 3 is a diagram illustrating a display attached to a vehicle including an apparatus for SVM-based parking assistance according to an embodiment of the present disclosure.

Referring to FIG. 3, the display of the output module 120 of the present disclosure may be located in a dashboard of the vehicle between the driver's seat and the passenger seat. However, the location of the display is not limited to the location shown in FIG. 3.

The display of the output module 120 may be divided into a first region 120a and a second region 120b. Referring to FIG. 3, the first region 120a may be located on the left side of the display 120, and the second region 120b may be located on the right side of the display 120. However, the screen of the display is not limited to the structure shown in FIG. 3. For example, the display may output the surrounding images captured by the cameras 110a to 110d to the screens 120a and 120b, respectively.

The input module 130 may apply power to the SVM system 100 or may set an image of the first region 120a or the second region 120b by receiving the driver's input. The input module 130 may include a touch panel. The input module 130 may be combined with the display of the output module 110 to be provided in a touch screen manner. For example, the input module 130 may be configured as an integrated module in which a touch panel is coupled to the central display 120 in a lamination structure. The input module 130 may detect the driver's touch input and output a touch event value corresponding to the detected touch signal. The touch panel may be implemented as various types of touch sensors, such as capacitive, resistive, or piezoelectric touch sensors.

The control module 200 may include at least one core capable of executing at least one instruction. The control module 200 may execute instructions stored in a memory. The control module 200 may be a single processor or a plurality of processors.

The control module 200 may include at least one of an advanced driver assistance system (ADAS), a central processing unit (CPU), a microprocessor, a graphic processing unit (GPU), an application specific integrated circuit (ASIC), or field programmable gate array (FPGA), but is not limited thereto.

The control module 200 may be implemented with hardware and software including the SVM system 100. The control module 200 may convert the collected image into a top-view image as if viewed from above the vehicle.

The control module 200 may include a machine learning model 220. For example, the control module 200 may recognize and process image data collected by the SVM system 100 using the machine learning model 220.

For example, the machine learning model 220 may detect a parking space (space detection) by calculating a relative distance between the parking space and a surrounding object (distance map), estimating a depth of the parking space (depth estimation), and segmenting a boundary of the parking space and a parking available region (segmentation) based on the image data collected by the SVM system 100.

For example, the machine learning model 220 may perform tasks, such as detecting objects (e.g., obstacles, parking lines, other vehicles, people, etc.) around the vehicle (object detection) and classifying the detected objects into parking lines, vehicles, obstacles, etc. (classification) based on the image data collected by the SVM system 100.

Accordingly, the control module 200 may determine whether the projected parking location is too narrow for parking or whether the driver cannot get in/out of the vehicle after manual parking.

Because it is known in the art of artificial intelligence to perform techniques, such as distance map (DM), depth estimation (DE), segmentation, object detection (OD), space detection (SD), object classification (OC), and space segmentation (SS) using the machine learning model 220, a detailed description thereof has been omitted.

The control module 200 may switch the top-view image displayed on the display 120 based on the driver's input. For example, when the user scrolls the touch panel of the input module 130, a top-view image with a region of interest changed according to the scroll input may be formed. When the user touches the touch panel of the input module 130, a top-view image with a region of interest changed according to the touch input may be formed. Meanwhile, a specific method of perspective transformation by changing a reference point according to a region of interest in a distorted vehicle surrounding image is known in the art of image processing, so a detailed description is omitted.

The control module 200 may be implemented as hardware and/or software including a parking assistance system, such as RSPA, RVM, PDW, PCA, etc. For example, the control module 200 may recognize the driver's input that activates (turns on) the RSPA system.

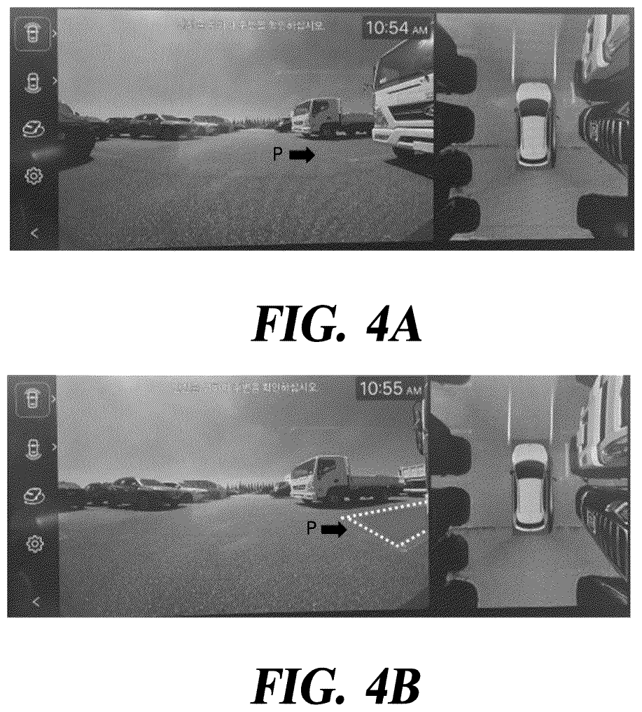

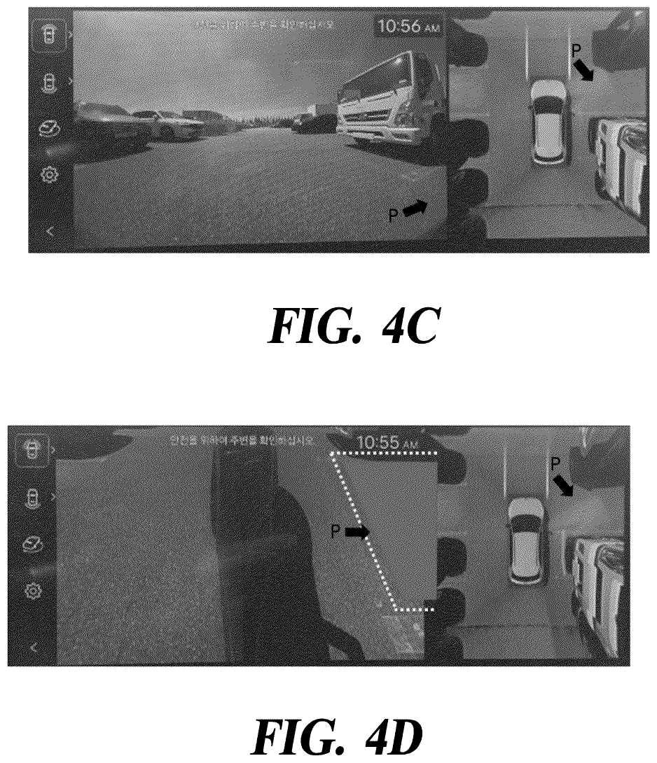

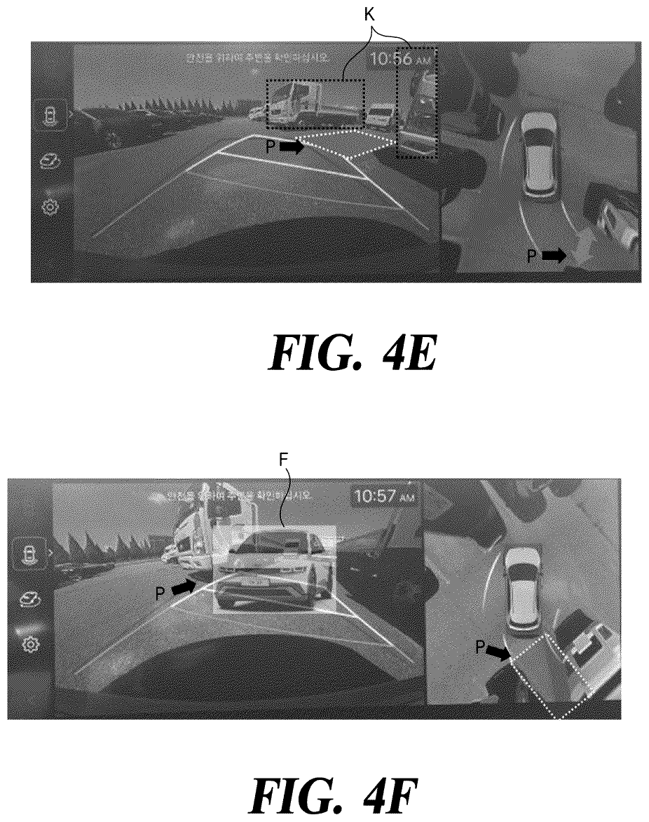

FIGS. 4A-4F are diagrams illustrating a sequence of operations from an operation before a vehicle to which an apparatus for SVM-based parking assistance is applied approaches a projected parking location to perform parking to an operation of moving backward to perform parking according to an embodiment of the present disclosure.

Referring to FIGS. 4A-4F, a vehicle surrounding image is displayed in the first region 120a. A top-view image of the vehicle is displayed in the second region 120b.

The images displayed on the display 120 of FIGS. 4A-4F are not limited to some of the embodiments illustrated in FIGS. 4A-4F. A person having ordinary skill in the art should recognize from the present disclosure that various omnidirectional top-view images having different sizes may be displayed in the second region 120b. A person having ordinary skill in the art should recognize from the present disclosure that various top-view image configurations may be displayed on the display 120, such as images displayed on the first region 120a and the second region 120b in an overlapping manner, images having different relative sizes, or images having different positions. A person having ordinary skill in the art should recognize from the present disclosure that additional or auxiliary screens may be added in addition to the first region 120a and the second region 120b. A person having ordinary skill in the art should recognize from the present disclosure that various images having different colors and surrounding regions may be displayed on the display 120.

FIG. 4A is a diagram illustrating an image displayed on the display 120 of the vehicle before the vehicle approaches a projected parking location P. The first region 120a of FIG. 4A displays a front image of the vehicle. The second region 120b of FIG. 4A displays a top-view image of the vehicle.

In the operation of FIG. 4A, the machine learning model 220 according to an embodiment of the present disclosure detects feature points of edges and corners of the projected parking location P based on image data from a front camera of the vehicle. The machine learning model 220 calculates a distance between feature points. The machine learning model 220 estimates the length and the width of a parking space. For example, the parking line of the projected parking location P may use a canny edge detection algorithm, and the vertex of the parking line may use a Harris corner detection algorithm.

FIG. 4B is a diagram illustrating an image displayed on the display 120 of the vehicle when the vehicle approaches the projected parking location P. The first region 120a of FIG. 4B displays a front image of the vehicle. The second region 120b of FIG. 4B displays a top-view image of the vehicle.

In the operation of FIG. 4B, the machine learning model 220 according to an embodiment of the present disclosure recognizes a floor parking line based on image data of the front camera of the vehicle and image data coming from a section next to the projected parking location P and performs virtual fitting if there is a hidden (erased) line, thereby correcting pixel-to-pixel distance information of the projected parking location P obtained in the operation of FIG. 4A.

The machine learning model 220 may correct the pixel-to-pixel distance information of the projected parking location P by sequentially compensating for the previous estimation result using continuous frames by time zone.

The machine learning model 220 may identify the projected parking location P based on surrounding vehicle information and parking line information acquired from the front/side cameras SD. The machine learning model 220 may identify the depth, distance, and width of the projected parking location P by using depth estimation (DE) and/or distance map (DM) techniques. The control module 200 may display visual information, such as dotted lines and squares (parking space, P in FIG. 4D) on the display so that the driver or passenger may visually identify the parking space or object based on the information identified by the machine learning model 220.

FIGS. 4C and 4D are diagrams illustrating images displayed on the display 120 of the vehicle when the vehicle is located right next to the projected parking location P. The first region 120a of FIG. 4C displays a front image of the vehicle. The second region 120b of FIG. 4C displays a top-view image of the vehicle. The first region 120a of FIG. 4D displays a side view image of the vehicle. The second region 120b of FIG. 4D displays a top view image of the vehicle.

The operations of FIGS. 4C and 4D are situations in which there is sufficient data on the projected parking location P collected in the previous operations. The control module 200 may reconfirm the value estimated in the previous operation for the projected parking location P by estimating the distance and width of the projected parking location P calculated in the previous operation.

The machine learning model 220 may identify the projected parking location P based on the surrounding vehicle information and parking line information acquired from the second region 120b of FIG. 4C and the first region 120a of FIG. 4D and may identify the distance and width of the projected parking location P by using the depth estimation (DE) and/or distance map (DM) techniques. The control module 200 may display visual information, such as dotted lines and squares, on the display so that the driver or passenger may visually identify the parking space or object based on the information identified by the machine learning model 220.

The control module 200 may provide the driver with information on whether parking is available and/or whether the driver may get in/out in the projected parking location P after parking based on the values estimated in the operations of FIG. 4A-FIG. 4D.

FIG. 4E is a diagram illustrating an image displayed on the display 120 of the vehicle when the vehicle is moving backward toward the projected parking location P to perform parking. The first region 120a of FIG. 4E displays a rear image of the vehicle. The second region 120b of FIG. 4E displays a top-view image of the vehicle.

The operation of FIG. 4E is an operation for providing a light warning and supplementary information on the projected parking location P based on the values calculated in the previous operations because it is a situation before the driver's intention is determined. For example, the control module 200 may provide a light warning, such as “The parking region is narrow, so please be careful,” to the driver based on the surrounding vehicle information and parking line information acquired in the operation of FIG. 4E.

The machine learning model 220 may identify the location, distance, width, etc. of the projected parking location P based on the surrounding vehicles and parking lines acquired in the operation of FIG. 4E (SD, DE, DM), may identify surrounding vehicles (OD, OC, and segmentation), and may display them on the display in a box shape (K of FIG. 4E).

FIG. 4F is a diagram illustrating an image displayed on the display 120 of the vehicle when the vehicle approaches the projected parking location P while moving backward to perform parking. The first region 120a of FIG. 4F displays a rear image of the vehicle. The second region 120b of FIG. 4F displays a top view image of the vehicle.

The operation of FIG. 4F is an operation of providing the driver with a parking completion prediction screen to assist the driver in deciding on a parking method.

The control module 200 may provide the driver with the parking completion prediction screen (G of FIG. 4F) by displaying a box shape showing a size of the vehicle on the display based on the assumption that parking is completed. The driver may decide on a parking method by referring to the parking completion prediction screen (G of FIG. 4F). For example, the driver may decide on manual parking as a parking method. Alternatively, the driver may determine that if the driver performs manual parking, it may be impossible for the driver or the passenger to get in/out of the vehicle because a pedestrian space is not sufficiently secured while parked. In the latter case, remote parking, such as RSPA, may be determined as a parking method.

During the process of attempting manual parking, the driver may use a parking assistance system, such as RVM, PDW, and PCA, together with the apparatus for SVM-based parking assistance of the present disclosure.

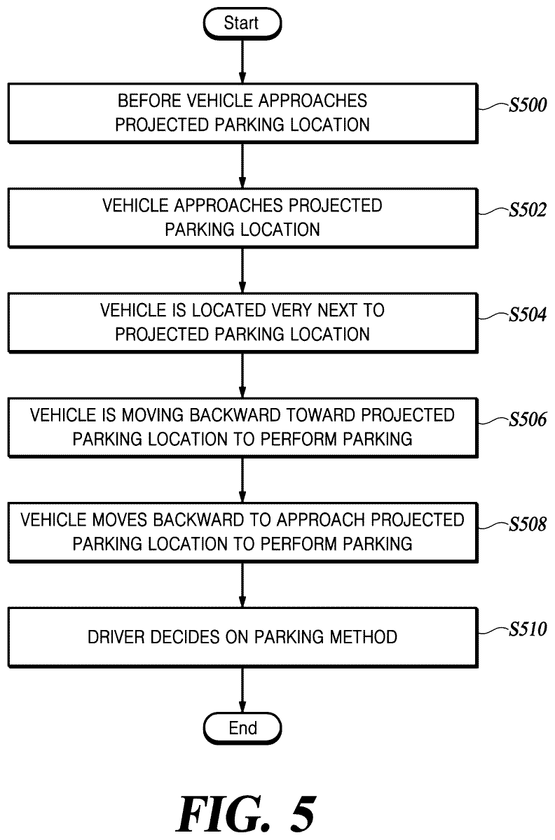

FIG. 5 is a flowchart schematically illustrating performing parking by an SVM-based parking assistance method according to an embodiment of the present disclosure.

A situation before the vehicle including the apparatus for SVM-based parking assistance of the present disclosure approaches the projected parking location is described. The machine learning model 220 may obtain approximate distance information between pixels of the projected parking location P based on the image data of the front camera (FIG. 4A). For example, the machine learning model 220 may use the canny edge detection algorithm to recognize the parking line of the projected parking location P and the Harris Corner Detection algorithm to recognize the vertex of the parking line (S500).

In the present disclosure, a situation in which the vehicle including the apparatus for SVM-based parking assistance is approaching the projected parking location is described. The machine learning model 220 recognizes a parking line on the floor based on the front camera image data (FIG. 4B). If there is a hidden (erased) line, the machine learning model 220 performs virtual fitting to correct the distance information between pixels of the projected parking location P obtained in the previous operation. For example, the machine learning model 220 may correct the distance information between pixels of the projected parking location P while sequentially supplementing the previous estimation result by using continuous frames by time zone based on the front camera image data (FIG. 4B). The machine learning model 220 may identify the location of the projected parking location P based on surrounding vehicles and parking line (FIG. 4B) acquired from the front/side cameras and may identify information on the distance and width (S502).

In the present disclosure, a situation in which the vehicle including the apparatus for SVM-based parking assistance is located right next to the projected parking location is described. The machine learning model 220 may estimate the location, the distance, and the width of the projected parking location P calculated in the previous operation based on camera image data (FIGS. 4C and 4D), thereby reconfirming the value estimated in the previous operation (S504). As an example, the control module 200 may display visual information, such as dotted lines and squares (parking space, P in FIG. 4D) on the display so that the driver or passenger may visually identify the parking space or object based on the information identified by the machine learning model 220 (S504).

In the present disclosure, a situation in which the vehicle including the apparatus for SVM-based parking assistance is moving backward toward the projected parking location to perform parking is described. The control module 200 may provide a light warning and supplementary information on the projected parking location P based on the values calculated in the previous operations. The control module 200 may provide a light warning, such as “The parking region is narrow, so please be careful,” to the driver based on the surrounding vehicle information and parking line information acquired from FIG. 4E. As another example, the control module 200 may identify the projected parking location P and surrounding vehicles by the machine learning model 220 based on camera image data (FIG. 4E) and may display them on the display in a box shape (K in FIG. 4E) (S506).

In the present disclosure, a situation in which the vehicle including the apparatus for SVM-based parking assistance is moving backward to approach the projected parking location P to perform parking is described. The control module 200 may provide the driver with the parking completion prediction screen (G of FIG. 4F) by displaying a box shape showing a size of the vehicle on the display based on the assumption that parking is completed (S508).

The driver may decide on whether to perform manual parking or use a parking assistance system, such as RSPA, based on the parking completion prediction screen (G in FIG. 4F). For example, if the driver determines that it is difficult for the driver to get in/out of the vehicle after completing manual parking, a ‘remote forward/backward’ or ‘smart parking’ function of RSPA may be used (S510).

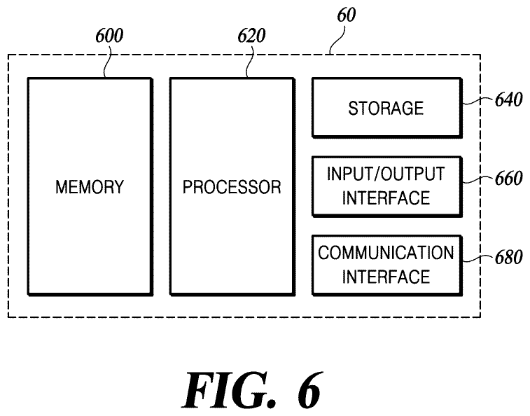

FIG. 6 is a diagram schematically illustrating a configuration of a computing device that may be used to implement the apparatus and methods described in the present disclosure.

A computing device 60 may include some or all of a memory 600, a processor 620, a storage 640, an input/output interface 660, or a communication interface 680. The computing device 60 may be a stationary computing device, such as a desktop computer, a server, etc., as well as a mobile computing device, such as a laptop computer, a smartphone, etc. The computing device 60 may include any specialized hardware accelerator capable of efficiently processing operations for the artificial intelligence model. For example, the computing device 60 may include a graphics processing unit (GPU), a tensor processing unit (TPU), or a neural processing unit (NPU).

The memory 600 may store a program that causes the processor 620 to perform a method or an operation according to various embodiments of the present disclosure. For example, the program may include a plurality of instructions executable by the processor 620, and the aforementioned method or operations may be performed by executing the plurality of instructions by the processor 620. The memory 600 may be a single memory or a plurality of memories. In this case, information required to perform the method or operation according to various embodiments of the present disclosure may be stored in the single memory or may be divided and stored in the plurality of memories. When the memory 600 includes a plurality of memories, the plurality of memories may be physically separated. The memory 600 may include at least one of volatile memory or nonvolatile memory. The volatile memory may include static random access memory (SRAM) or dynamic random access memory (DRAM), and the nonvolatile memory may include flash memory.

The processor 620 may include at least one core capable of executing at least one instruction. The processor 620 may execute instructions stored in the memory 600. The processor 620 may be a single processor or a plurality of processors.

The storage 640 maintains stored data even when power supplied to the computing device 60 is cut off. For example, the storage 640 may include nonvolatile memory or may include a storage medium, such as a magnetic tape, an optical disk, or a magnetic disk. The program stored in the storage 640 may be loaded into the memory 600 before being executed by the processor 620. The storage 640 may store a file written in a programming language, and a program generated from the file by a compiler or the like may be loaded into the memory 600. The storage 640 may store data to be processed by the processor 620 and/or data processed by the processor 620.

The input/output interface 660 may provide an interface with an input device, such as a keyboard, a mouse, etc. and/or an output device, such as a display device, a printer, etc. A user may trigger the execution of a program by the processor 620 through the input device and/or check a processing result of the processor 620 through the output device.

The communication interface 680 may provide access to an external network. The computing device 60 may communicate with other devices through the communication interface 680.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely a description of the technical idea of one embodiment of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed invention. Therefore, embodiments of the present disclosure have been described for the sake of brevity and clarity. The scope of the technical idea of the present embodiments is not limited by the illustrations. Accordingly, one of ordinary having ordinary skill in the art should understand that the scope of the present disclosure should not be limited by the above explicitly described embodiments but by the claims and equivalents thereof.

What is claimed is

1. A method for performing a surround view monitor (SVM)-based parking assistance by utilizing a machine learning model, the method comprising:
acquiring, by a plurality of cameras, a vehicle surrounding image;
detecting, by the machine learning model, feature points of an edge and a corner of a parking space based on the vehicle surrounding image;
calculating, by the machine learning model, a distance between the feature points;
estimating, by the machine learning model, at least one of a location, a length, or a width of the parking space;
providing, by a control module, the vehicle surrounding image and visual information on a display of a vehicle;
determining, by the vehicle, whether parking in the parking space is possible; and
performing, by the vehicle, autonomous parking based on a determination of whether parking in the parking space is possible.

2. The method of claim 1, wherein estimating at least one of the location, the length, or the width of the parking space includes:
detecting an object and a parking space around the vehicle;
calculating a relative distance between the parking space and the object;
estimating a depth of the parking space;
segmenting a boundary of the parking space and a parking available region; and
classifying the object into a parking line, a vehicle, or an obstacle.

3. The method of claim 2, wherein the visual information includes:
a dotted line and a square showing the object and the parking space on the display.

4. The method of claim 2, wherein the visual information includes:
a box shape showing a size of the vehicle in the parking space on the display.

5. The method of claim 1, wherein the vehicle surrounding image includes:
an object and a space around the vehicle in at least one of a 360-degree variable 3D view or a top view.

6. The method of claim 1, wherein performing autonomous parking comprises:
performing parking by at least one of remote forward/backward or smart parking by a smart parking assist (RSPA) system, based on a determination that manual parking is impossible based on the visual information.

7. The method of claim 1, further comprising:
utilizing at least one of a rear view monitor (RVM), a parking distance warning (PDW), or a parking collision-avoidance assist (PCA).

8. An apparatus for performing a surround view monitor (SVM)-based parking assistance by utilizing a machine learning model, the apparatus comprising:
at least one memory configured to store instructions; and
at least one processor configured, by executing the instructions, to:
acquire a vehicle surrounding image by using a plurality of cameras;
detect feature points of an edge and a corner of a parking space based on the vehicle surrounding image by using the machine learning model;
calculate a distance between the feature points by using the machine learning model;
estimate at least one of a location, a length, or a width of the parking space by using the machine learning model;
provide the vehicle surrounding image and visual information on a display of a vehicle;
determine whether parking in the parking space is possible; and
perform autonomous parking based on a result of whether parking in the parking space is possible.

9. The apparatus of claim 8, wherein the at least one processor is further configured to:
detect an object and a parking space around the vehicle;
calculate a relative distance between the parking space and the object;
estimate a depth of the parking space;
segment a boundary of the parking space and a parking available region; and
classify the object into a parking line, a vehicle, or an obstacle.

10. The apparatus of claim 9, wherein the visual information includes:
a dotted line and a square showing the object and the parking space on the display.

11. The apparatus of claim 9, wherein the visual information includes:
a box shape showing a size of the vehicle in the parking space on the display.

12. The apparatus of claim 8, wherein the vehicle surrounding image includes:
an object and a space around the vehicle in at least one of a 360-degree variable 3D view or a top view.

13. The apparatus of claim 8, wherein the at least one processor is further configured to:
park by at least one of remote forward/backward or smart parking by a smart parking assist (RSPA) system, when it is determined that manual parking is impossible based on the visual information.

14. The apparatus of claim 8, wherein the at least one processor is further configured to:
utilize at least one of a rear view monitor (RVM), a parking distance warning (PDW), or a parking collision-avoidance assist (PCA).
